(19) United States
(12) Patent Application Publication
(10) Pub. No.: US 2019/0220632 A1
(43) Pub. Date: Jul. 18, 2019

(54) WIRELESS MONITORING DEVICE FOR A PEST OR ANIMAL TRAP AND RELATED TECHNIQUES

(71) Applicant: Vypin, LLC, Alpharetta, GA (US)

(72) Inventor: Robert William Sengstaken, JR., Hollis, NH (US)

(21) Appl. No.: 16/359,413

(22) Filed: Mar. 20, 2019

Related U.S. Application Data
(63) Continuation-in-part of application No. 16/178,864, filed on Nov. 2, 2018.
Application No. 16/178,864 is a continuation of application No. 14/304,195, filed on Jun. 13, 2014, now Pat. No. 10,121,028.
(60) Provisional application No. 62/645,518, filed on Mar. 20, 2018.
(60) Provisional application No. 61/839,561, filed on Jun. 26, 2013.
(60) Provisional application No. 61/902,316, filed on Nov. 11, 2013.
(60) Provisional application No. 61/902,325, filed on Nov. 11, 2013.
(60) Provisional application No. 61/974,770, filed on Apr. 3, 2014.

(51) Int. Cl. G06K 7/10; A61J 1/03; A61J 7/04; G06K 19/07

(52) U.S. Cl. CPC G06K 7/10009; A61J 1/035; A61J 7/04; G06K 19/0717; G06K 19/0723; A61J 7/049; A61J 2200/30; G06K 19/0716; A61J 7/0454; A61J 7/0472; A61J 7/0481; A61J 7/0436; G06K 19/0702

(57) ABSTRACT

A wireless monitoring device configured to monitor for triggering of a pest or animal trap with which the device is associated is disclosed. The device may be configured to detect either (or both): (1) the motion of the trap when triggered/actuated; and (2) the motion of a trapped organism. The device may be configured to transmit, in response to detecting the motion, a radio frequency (RF) signal including data pertaining to the status of the trap, allowing for easy determination of whether the trap is in an armed or triggered state. The RF signal may be received by any wireless infrastructure, such as a gateway or computing device (or other reader), within range, and information from the RF signal may be delivered through the internet/cloud to a server database. Information stored at the server database may be accessed to monitor and track trap status and control overall system operation.

### CROSS-REFERENCE TO RELATED APPLICATIONS

This patent application claims the benefit of U.S. Provisional Patent Application No. 62/645,518, filed on Mar. 20, 2018. This patent application also is a Continuation-in-Part of U.S. patent application Ser. No. 16/178,864, filed on Nov. 2, 2018, which is a Continuation of U.S. patent application Ser. No. 14/304,195 filed on Jun. 13, 2014, which claims the benefit of each of: (a) U.S. Provisional Patent Application No. 61/839,561, filed on Jun. 26, 2013; (b) U.S. Provisional Patent Application No. 61/902,316, filed on Nov. 11, 2013; (c) U.S. Provisional Patent Application No. 61/902,325, filed on Nov. 11, 2013; and (d) U.S. Provisional Patent Application No. 61/974,770, filed on Apr. 3, 2014. Each of these patent applications is herein incorporated by reference in its entirety.

### FIELD OF THE DISCLOSURE

The present disclosure relates to wireless sensing and more particularly to a wireless trap monitoring device and related techniques.

### BACKGROUND

A wide variety of pest and animal traps exist. Such traps may be lethal or non-lethal by design. Routine inspection and monitoring may be recommended or even required depending on design, placement, and targeted organism(s).

### SUMMARY

The subject matter of this application may involve, in some cases, interrelated products, alternative solutions to a particular problem, and/or a plurality of different uses of a single system or article.

One example embodiment provides a wireless monitoring device. The wireless monitoring device includes a motion detection sensor configured to detect at least one of: movement of a pest or animal trap with which the wireless monitoring device is operatively interfaced; and movement of an organism trapped by such trap. The wireless monitoring device also includes a wireless transmitter configured to transmit a radio frequency (RF) signal including data pertaining to: the detected movement; and a unique identifier associated with the wireless monitoring device. The wireless monitoring device also includes a processing element configured to instruct the wireless transmitter to transmit the RF signal in response to detection of the movement by the motion detection sensor.

In some cases, the motion detection sensor is configured to output a first wake-up signal, which first wake-up signal results in the processing element transitioning out of a first low-power state and outputting a second wake-up signal to the wireless transmitter, which second wake-up signal results in the wireless transmitter transitioning out of a second low-power state and transmitting the RF signal.

In some cases, the wireless transmitter is configured to: periodically transmit the RF signal at a first transmission rate; and transmit, for a designated period, the RF signal at a second transmission rate upon the movement detection, wherein the second transmission rate is greater than the first transmission rate. In some such instances, the wireless transmitter is configured to transmit the RF signal at the second transmission rate until at least one of: the wireless monitoring device is reset from a triggered state to an armed state; a predetermined amount of time has elapsed; a power supply of the wireless monitoring device is depleted; and the wireless monitoring device is turned off.

In some cases, the wireless transmitter is configured to transmit the RF signal periodically.

In some cases, the wireless transmitter is configured to transmit the RF signal: at a first transmission rate when the wireless monitoring device is in a low-power state; and at a second transmission rate when the wireless monitoring device is in an active state, wherein the second transmission rate is greater than the first transmission rate.

In some cases, the wireless transmitter is configured as a wireless transceiver device, having both wireless transmission and wireless reception capabilities.

In some cases, the wireless monitoring device further includes a timer configured to output a first wake-up signal, which first wake-up signal results in the processing element transitioning out of a first low-power state and outputting a second wake-up signal to the wireless transmitter, which second wake-up signal results in the wireless transmitter transitioning out of a second low-power state and transmitting the RF signal. In some such instances, the timer is configured to output the first wake-up signal periodically.

In some cases, the RF signal is either: a Bluetooth signal of a frequency in the range of 2.4-2.485 GHz; a long range (LoRa) signal of a frequency in a 915 MHz ISM band; or a cellular signal.

In some cases, the RF signal further includes data pertaining to at least one of: a manufacture code associated with the wireless monitoring device; a status of the wireless monitoring device; a power level of a power supply of the wireless monitoring device; a sequence number pertaining to a unique data packet of the RF signal; and an output of a sensor of the wireless monitoring device.

In some cases, the wireless monitoring device further includes a button configured to at least one of: arm and reset the wireless monitoring device; wake the wireless monitoring device from a low-power state; and begin a time delay for arming the wireless monitoring device.

In some cases, a system is provided, the system including: a wireless monitoring device configured as provided herein; and a trap, wherein the wireless monitoring device is formed integrally with the trap.

In some cases, a system is provided, the system including: a wireless monitoring device configured as provided herein; and a trap, wherein the wireless monitoring device is operatively interfaced with the trap via a holder.

Another example embodiment provides a method of wirelessly monitoring a pest or animal trap. The method includes detecting, via a motion detection sensor of a wireless monitoring device operatively interfaced with the trap, at least one of: movement of the trap; and movement of an organism trapped by the trap. The method further includes transmitting, via a wireless transmitter of the wireless monitoring device, a radio frequency (RF) signal including data pertaining to: the detected movement; and a unique identifier associated with the wireless monitoring device.

In some cases, the method further includes outputting, via the motion detection sensor, a first wake-up signal, which first wake-up signal results in a processing element of the wireless monitoring device transitioning out of a first low-power state and outputting a second wake-up signal to the wireless transmitter, which second wake-up signal results in the wireless transmitter transitioning out of a second low-power state and transmitting the RF signal.

In some cases, the transmitting of the RF signal occurs: periodically at a first transmission rate; and for a designated period at a second transmission rate upon the movement detection, wherein the second transmission rate is greater than the first transmission rate. In some such instances, the transmitting of the RF signal at the second transmission rate occurs until at least one of: the wireless monitoring device is reset from a triggered state to an armed state; a predetermined amount of time has elapsed; a power supply of the wireless monitoring device is depleted; and the wireless monitoring device is turned off.

In some cases, the RF signal is either: a Bluetooth signal of a frequency in the range of 2.4-2.485 GHz; a long range (LoRa) signal of a frequency in a 915 MHz ISM band; or a cellular signal.

In some cases, the RF signal further includes data pertaining to at least one of: a manufacture code associated with the wireless monitoring device; a status of the wireless monitoring device; a power level of a power supply of the wireless monitoring device; a sequence number pertaining to a unique data packet of the RF signal; and an output of a sensor of the wireless monitoring device.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 is a block diagram illustrating a wireless monitoring system configured in accordance with an embodiment of the present disclosure.

FIG. 2 is a block diagram of a wireless monitoring device configured in accordance with an embodiment of the present disclosure.

FIG. 3 is a flow diagram illustrating a method of operating a wireless monitoring device in accordance with an embodiment of the present disclosure.

These and other features of the present embodiments will be understood better by reading the following detailed description, taken together with the figures herein described. In the drawings, each identical or nearly identical component that is illustrated in various figures may be represented by a like numeral. For purposes of clarity, not every component may be labeled in every drawing. Furthermore, as will be appreciated in light of this disclosure, the accompanying drawings are not intended to be drawn to scale or to limit the described embodiments to the specific configurations shown.

### DETAILED DESCRIPTION

A wireless monitoring device configured to monitor for triggering of a pest or animal trap with which the device is associated is disclosed. In accordance with some embodiments, the disclosed device may be configured to detect either (or both): (1) the motion of the trap when triggered/actuated; and (2) the motion of an organism trapped by the trap. In accordance with some embodiments, the disclosed device may be configured to transmit, in response to detecting the motion, a radio frequency (RF) signal including data pertaining to the status of the trap, allowing for easy determination of whether the trap is in an armed state or a triggered state. The RF signal may be received by any wireless infrastructure, such as a gateway or computing device (or other reader), within range, and information from the RF signal may be delivered through the internet/cloud to a server database, which may be cloud-based in some instances. Information stored at the server database may be accessed to monitor and track the trap status and control overall system operation. Numerous configurations and variations will be apparent in light of this disclosure.

General Overview

Pest and animal traps, including those for rodents such as rats and mice, have long been in use. Existing approaches, however, require regular inspection to determine whether a trapped organism has been caught and/or killed. Live/humane traps typically must be inspected daily or otherwise frequently to remove the live organism humanely. Regardless of its intended lethality, if a trap is not checked regularly, a trapped organism may decay after death, producing unpleasant odors and cleanup and presenting a general health hazard. Moreover, traps are often placed in locations that are difficult to access, such as in attics and crawlspaces, for example.

Thus, and in accordance with some embodiments of the present disclosure, a wireless monitoring device configured to monitor for triggering of a pest or animal trap with which the device is associated is disclosed. In accordance with some embodiments, the disclosed device may be configured to detect either (or both): (1) the motion of the trap when triggered/actuated; and (2) the motion of an organism trapped by the trap. In accordance with some embodiments, the disclosed device may be configured to transmit, in response to detecting the motion, a radio frequency (RF) signal including data pertaining to the status of the trap, allowing for easy determination of whether the trap is in an armed state or a triggered state. The RF signal may be received by any wireless infrastructure, such as a gateway or computing device (or other reader), within range, and information from the RF signal may be delivered through the internet/cloud to a server database, which may be cloud-based in some instances. Information stored at the server database may be accessed to monitor and track trap status and control overall system operation.

As will be appreciated in light of this disclosure, the disclosed device may be utilized with any suitable pest or animal trap, existing, customized, or proprietary. Moreover, a given user (e.g., homeowner, pest control technician, etc.) may use the device with ease, and in most cases the device may be reusable. In some cases, the disclosed device may be configured to alert a given party, such as the homeowner or a pest or animal control company, for example, that a given trap may require inspection, clearing, or resetting. In accordance with some embodiments, the disclosed wireless monitoring device generally may be considered a retrofit component compatible for use with any of a wide range of existing traps.

As discussed herein, the disclosed wireless monitoring device may be configured to transmit an RF signal including data pertaining to the status of an associated trap. The RF signal, in turn, may be received by either (or both) a mobile computing device (e.g., such as a smartphone or a tablet computer) or a fixed gateway within range. Either (or both) the mobile computing device and fixed gateway may provide an alert (e.g., such as a text message, an electronic mail/e-mail message, etc.) to a given user that the trap has been triggered and may require attention. As will be appreciated in light of this disclosure, this communication channel may help to reduce the need for frequent inspection of any deployed traps by a given user. Moreover, in accordance with some embodiments, a single mobile computing device may be utilized to monitor for RF signals from any quantity of traps having wireless monitoring devices configured as described herein.

In accordance with some embodiments, a given wireless monitoring device provided as described herein may have a unique identifier associated therewith. Thus, when deployed with a given trap, the wireless monitoring device may serve to uniquely identify the associated trap. A given mobile computing device setup to monitor such wireless monitoring devices may have an application thereon, via which the status of each detected trap may be reviewed. In some cases, each individual trap and associated wireless monitoring device may be labeled with the unique identifier such that a user may determine with ease where a given triggered trap is deployed.

Structure/System Architecture and Operation

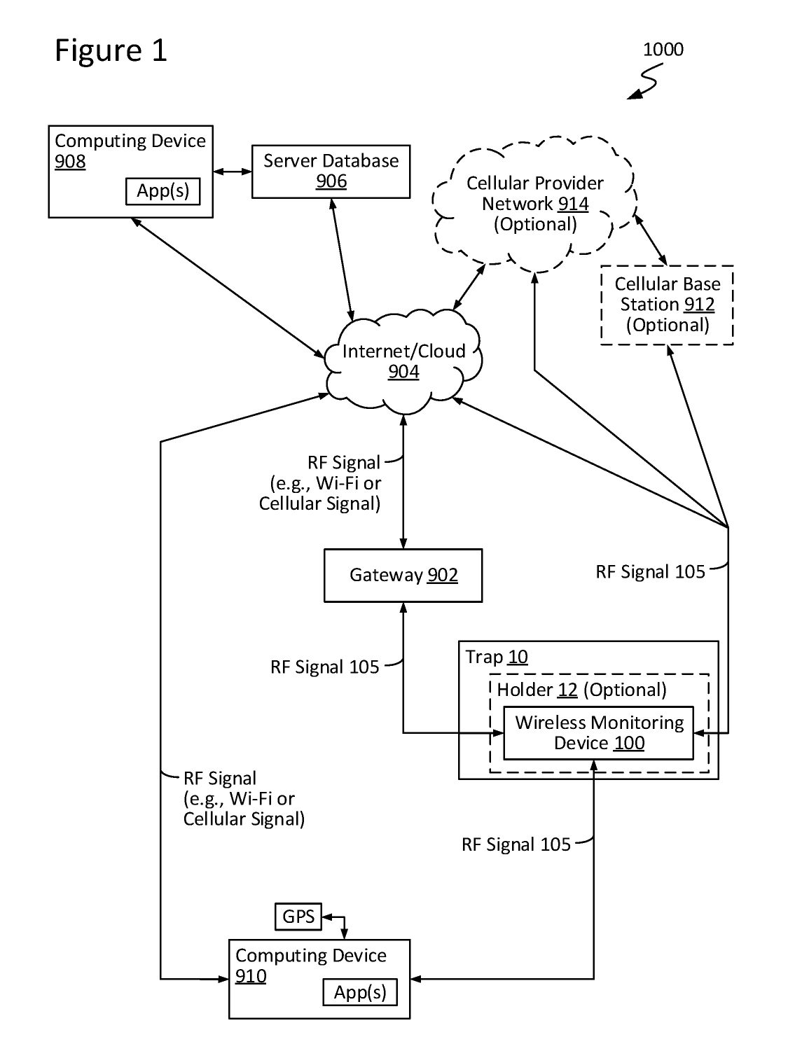

FIG. 1 is a block diagram illustrating a wireless monitoring system 1000 configured in accordance with an embodiment of the present disclosure. As can be seen, system 1000 may include a wireless monitoring device 100 operatively interfaced with (e.g., mounted to, positioned in physical contact with, or otherwise disposed sufficiently proximate to) a pest or animal trap 10 (optionally via a holder 12). As can be seen further, system 1000 may include a gateway 902 and a server database 906. Moreover, system 1000 may involve in its operation one or more computing devices 908, 910 and the internet/cloud 904. In accordance with some embodiments, system 1000 may involve in its operation one or more cellular data elements, such as a cellular base station 912 and a cellular provider network 914. Each of these various elements is discussed in turn below. More generally, FIG. 1 illustrates communicative coupling of the various constituent elements of system 1000 and the overall flow of data within system 1000, in accordance with some embodiments.

As described herein, wireless monitoring device 100 may be configured, in accordance with some embodiments, to be hosted by a trap 10 such that it can sense either (or both): (1) movement of trap 10, such as when triggered; or (2) movement of an organism trapped by trap 10. In this manner, device 100 may be utilized in monitoring whether an associated trap 10 is in an armed state or a triggered state and reporting such trap status to one or more other elements of system 1000 more generally.

In accordance with some embodiments, trap 10 may be configured as a lethal or non-lethal trap for pests or animals (e.g., rodents, insects, etc.) or any other organism of interest, as desired. To that end, trap 10 may be of any suitable existing, proprietary, or customized configuration. In at least some cases, trap 10 may exhibit movement (e.g., motion of at least one component) when triggered or full. For instance, if trap 10 is a typical spring-loaded mouse trap, triggering thereof releases the spring-loaded mechanism rapidly, such action imparting some amount of movement to trap 10 generally. Of course, the present disclosure is not intended to be limited only to use with spring-loaded traps, as any of a wide range of traps that exhibit varying degrees of movement may be utilized, in accordance with some embodiments. In at least some other cases, trap 10 itself may not exhibit movement when triggered or full, and thus movement of the trapped organism may be relied upon, in part or in whole. Numerous suitable configurations for trap 10 will be apparent in light of this disclosure.

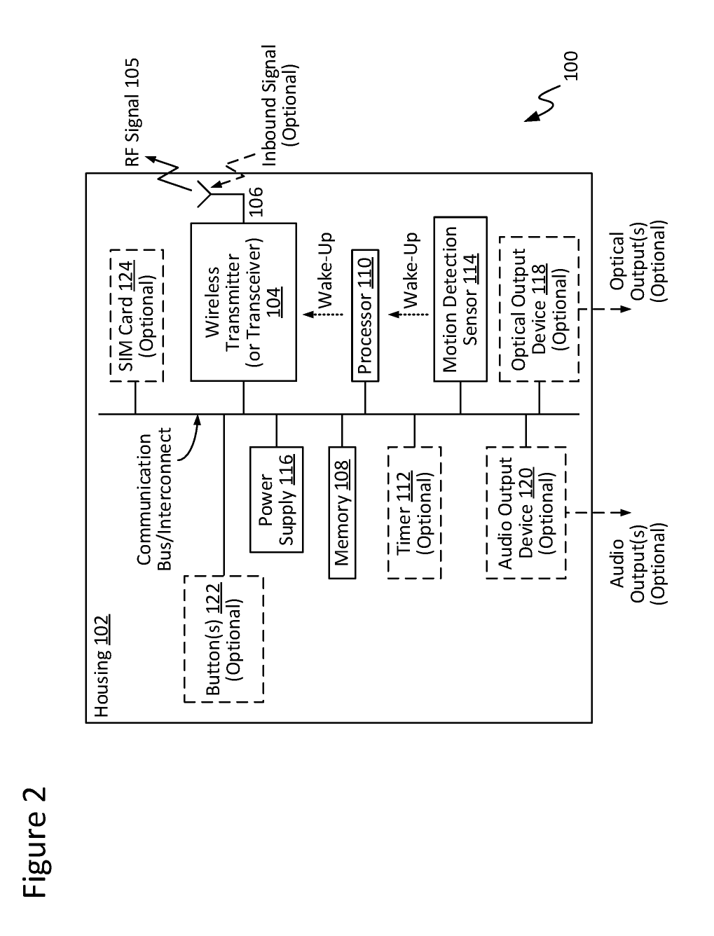

FIG. 2 is a block diagram of a wireless monitoring device 100 configured in accordance with an embodiment of the present disclosure. As discussed herein, device 100 may be configured, in accordance with some embodiments, to be operatively interfaced with a trap 10 such that it can detect either (or both) the action or other motion of trap 10 when triggered or movement of an organism trapped by trap 10. To that end, in some embodiments, device 100 may be configured to be mounted, directly or indirectly, on trap 10. In some instances, an optional holder 12, such as one or more straps, a bracket, a plate, or any other suitable intervening mounting means, as will be apparent in light of this disclosure, may be utilized. In some embodiments, device 100 may be configured to be disposed beneath or otherwise placed in physical contact (e.g., physical abutment) with trap 10. As will be appreciated in light of this disclosure, at least in some embodiments, device 100 generally may be considered a stand-alone component, separate from trap 10. In some other cases, however, device 100 may be configured to be integrated, in part or in whole, with trap 10. In a more general sense, device 100 may be provided as either a native component of trap 10 or non-native to trap 10, as desired.

In accordance with some embodiments, device 100 may include a housing 102 configured to house, in part or in whole, any of the various components of device 100. The material construction and dimensions of housing 102 may be customized, as desired for a given target application or end-use. In some cases, housing 102 may be substantially flat in profile, thereby minimizing or otherwise reducing the physical obtrusiveness (if any) of device 100 to the trap 10 associated with it.

In accordance with some other embodiments, housing 102 may be configured to be mounted or otherwise operatively interfaced with a trap 10 using any of a wide range of suitable interfacing means. For instance, in accordance with some embodiments, device 100 may be configured for interfacing with trap 10 via any one, or combination, of mechanical fasteners (e.g., such as clamps, clips, brackets, and threaded or rope-like means, to name a few), adhesive materials (e.g., glue, epoxy, and hook-and-loop fasteners, to name a few), and magnets. In some embodiments, housing 102 may be configured to be operatively interfaced with trap 10 via an optional holder 12. Other suitable configurations for housing 102 and any related mounting means will depend on a given application and will be apparent in light of this disclosure.

In accordance with some embodiments, device 100 may include a wireless transmitter 104, which may be either a dedicated transmitter device provided with only transmitting capabilities or a transceiver device provided with both transmitting and receiving capabilities. In some instances where wireless transmitter 104 is a transceiver device, it may be configured to receive signal(s) from an external source, such as a given computing device 908, 910 (discussed below), for example, when configuring device 100. In some embodiments, wireless transmitter 104 may be (or otherwise may include) a short-wavelength ultra-high frequency (UHF) radio wave Bluetooth-compatible device configured to transmit and/or receive signals of a frequency in the range of about 2.4-2.485 GHz. In some embodiments, wireless transmitter 104 may be (or otherwise may include) a long range (LoRa)-compatible device configured to transmit and/or receive signals of a frequency in a 915 MHz ISM band. In some embodiments, wireless transmitter 104 may be (or otherwise may include) a cellular modem configured to transmit and/or receive cellular signals. In some embodiments, device 100 further may include a subscriber identity module (SIM) card 124 configured to be in communication with wireless transmitter 104 in support of cellular capabilities.

As a wireless communication device, wireless transmitter 104 may include an antenna 106 configured to transmit and/or receive one or more signals, such as a radio frequency (RF) signal 105 (discussed below). To that end, antenna 106 may be, for example, a printed circuit board (PCB) antenna configured as typically done or any other suitable antenna, as will be apparent in light of this disclosure. Other suitable configurations for wireless transmitter 104 and its antenna 106 will depend on a given application and will be apparent in light of this disclosure.

In some embodiments, wireless transmitter 104 may be configured to transmit RF signal 105 periodically, as desired for a given target application or end-use. In some embodiments, wireless transmitter 104 may be configured to transmit RF signal 105 from device 100 at a repetition rate of one transmission per 1-10 seconds, per hour, or per day, though greater or lesser transmission rates may be provided, in accordance with other embodiments. In some embodiments, wireless transmitter 104 may be configured to periodically transmit RF signal 105 at a first transmission rate and transmit, for a designated period, RF signal 105 at a second transmission rate upon movement detection by motion detection sensor 114, wherein the second transmission rate is greater than the first transmission rate. In some embodiments, wireless transmitter 104 may be configured to transmit RF signal 105 at a given transmission rate until device 100 has been reset from a triggered state to an armed state, a predetermined amount of time has elapsed, a power supply 116 of device 100 has depleted, and/or device 100 has been turned off In some embodiments, wireless transmitter 104 may be configured to transmit RF signal 105 at a first transmission rate when device 100 is in a low-power state and at a second transmission rate when device 100 is in an active state, wherein the second transmission rate is greater than the first transmission rate.

Device 100 further may include memory 108, which may be implemented with any one, or combination, of volatile and non-volatile memory and may be of any type and size, as desired for a given target application or end-use. In some cases, memory 108 may be configured for use in storing data, on a temporary or permanent basis, whether that data is native to device 100 or received from another source. In some instances, memory 108 may be configured for use as processor workspace for processor 110 (discussed below).

In accordance with some embodiments, memory 108 may be (or otherwise may include), for example, a computer-readable medium that, when executed by a processor (e.g., such as processor 110), carries out any one or more of the functions described herein, in part or in whole. The computer-readable medium may be, for example, a hard drive, a compact disk, a memory stick, a server, or any other suitable non-transitory computer or computing device memory that includes executable instructions, or a plurality or combination of such memories. Other embodiments may be implemented, for instance, with gate-level logic or an application-specific integrated circuit (ASIC) or chip set, or other such purpose-built logic. Some embodiments may be implemented with a microcontroller having input/output (I/O) capability (e.g., inputs for receiving user inputs; outputs for directing other components) and one or more embedded routines for carrying out device functionality. In a more general sense, memory 108 may be implemented in hardware, software, firmware, or a combination thereof, as desired for a given target application or end-use. Other suitable configurations for memory 108 will depend on a given application and will be apparent in light of this disclosure.

In addition, device 100 may include a processor 110, which may be configured to communicate with any one, or combination, of the other various components of device 100 via a communication bus or other suitable interconnect. Processor 110 may be, for example, a central processing unit (CPU), a microcontroller unit (MCU), or any other suitable processing element, as will be apparent in light of this disclosure. In performing a given operation associated with device 100, processor 110 may be configured to access data stored at memory 108 or otherwise accessible to device 100. In accordance with some embodiments, processor 110 may be configured for either (or all) Bluetooth protocol, LoRa protocol, and cellular protocol. Other suitable configurations for processor 110 will depend on a given application and will be apparent in light of this disclosure.

In some embodiments, device 100 optionally may include a timer 112 which is configured to control periodic transmissions of RF signal 105 using processor 110. To that end, timer 112 may be configured to output a wake-up signal to processor 110 at a given repetition rate (e.g., one transmission per hour, day, or otherwise), which may be customized, as desired for a given target application or end-use. Thus, in accordance with some embodiments, the operability and presence of device 100 at an associated trap 10 may be checked daily or as otherwise desired. In response to receipt of the wake-up signal from timer 112, processor 110 may send another wake-up signal to wireless transmitter 104 and instruct it to transmit RF signal 105. Timer 112 may be implemented in hardware, software, firmware, or some combination thereof. In some embodiments, timer 112 may be integrated with processor 110. Other suitable configurations for timer 112 will depend on a given application and will be apparent in light of this disclosure.

In accordance with some embodiments, device 100 may include a motion detection sensor 114, which may be a micro-electromechanical system (MEMS) accelerometer device or any other suitable motion detection device, as will be apparent in light of this disclosure. Motion detection sensor 114 may be configured to detect movement (e.g., translational movement, rotational movement, and so on) of device 100 or an impact to device 100 (e.g., such as a single-tap or double-tap on a housing 102 of device 100). In at least some embodiments, motion detection sensor 114 may be configured to detect either (or both): (1) movement of a trap 10 with which device 100 is associated, such as when that trap 10 is triggered; or (2) movement of an organism trapped by a trap 10 with which device 100 is associated. Motion detection sensor 114 may be configured, in accordance with some embodiments, to output a wake-up signal (e.g., an IRQ signal) to processor 110 in response to its activation as caused by a detected movement or impact. In response to receipt of this wake-up signal, processor 110 may transition out of a low-power state (e.g., a sleep-state or an off-state) and instruct wireless transmitter 104 to transmit RF signal 105 (discussed below) externally from device 100. In this manner, processor 110 may remain in a low-power state (e.g., a sleep-state or off-state) until device 100 is moved or impacted. Other suitable configurations for motion detection sensor 114 will depend on a given application and will be apparent in light of this disclosure.

In accordance with some embodiments, device 100 may include a power supply 116, which may be configured to supply a given target amount of power to any of the various components of device 100. In some embodiments, power supply 116 may be a battery, which may be permanent or replaceable. In some cases, power supply 116 may include (or otherwise be operatively coupled with) a photovoltaic module (e.g., a solar cell) configured to convert light energy to electrical energy for use by device 100. In accordance with some embodiments, processor 110 may be configured to check the power level of power supply 116 periodically or as otherwise desired. Other suitable configurations for power supply 116 will depend on a given application and will be apparent in light of this disclosure.

In accordance with some embodiments, device 100 optionally may include one or more optical output devices 118, which may be a solid-state light source, such as a light-emitting diode (LED), or any other device capable of emitting light of a given wavelength, optionally with a given emission period or pattern. In an example case, device 100 may include a first optical output device 118 configured to emit light of a first color (e.g., green light) and a second optical output device 118 configured to emit light of a different second color (e.g., red light). In another example case, device 100 may include a single optical output device 118 configured to emit multiple colors, such as the first and second colors previously noted. A given optical output device 100 may be configured, in accordance with some embodiments, to output optical output signal(s) indicative of a given condition with respect to the operation of device 100 (or system 1000 more generally). For instance, in some cases, a given optical output device 118 may be configured to emit light indicative of any one, or combination, of turning on, arming/disarming, resetting, and turning off device 100. Other suitable configurations and uses for optional optical output device(s) 118 will depend on a given application and will be apparent in light of this disclosure.

In accordance with some embodiments, device 100 optionally may include an audio output device 120, which may be a speaker, beeper, or any other device capable of emitting sound of a given frequency, optionally with a given emission period or pattern. A given audio output device 120 may be configured, in accordance with some embodiments, to output audio output signal(s) indicative of a given condition with respect to the operation of device 100 (or system 1000 more generally). For instance, in some cases, a given audio output device 120 may be configured to emit sound(s) indicative of any one, or combination, of turning on, arming/disarming, resetting, and turning off device 100. Other suitable configurations and uses for optional audio output device 120 will depend on a given application and will be apparent in light of this disclosure.

In accordance with some embodiments, device 100 optionally may include one or more buttons 122, which may be programmable and either a physical control feature (e.g., a physical button, switch, knob, pressure sensor, toggle, slider, and so forth) or a virtual control feature (e.g., a touch-sensitive icon or other element providing any one or more of the aforementioned physical control feature functionalities). In an example case, device 100 may include a button 122 that, when pressed, causes device 100 to emit RF signal 105. In another example case, device 100 may include a button 122 that, when pressed, causes device 100 to any one, or combination, of turn on, arm/disarm, reset, and turn off. In another example case, device 100 may include a button 122 that, when pressed, causes device 100 to enter into a programming mode by which the settings and operation of device 100 may be customized. In another example case, device 100 may include a button 122 that, when pressed, causes device 100 to perform a power level check for power supply 116. In some cases, a given button 122 may be configured to arm and/or reset device 100. In some cases, a given button 122 may be configured to wake device 100 from a low-power state. In some cases, a given button 122 may be configured to begin a time delay for arming device 100. Other suitable configurations and functions for button(s) 122 will depend on a given application and will be apparent in light of this disclosure.

It should be noted that device 100 is not intended to be limited only to the example configurations described above and illustrated in FIG. 2, for example, as numerous other configurations and variations will be apparent in light of this disclosure. For instance, in some other embodiments, any (or all) of memory 108, processor 110, and wireless transmitter 104 may be provided as a single device having the capabilities of each attendant component.

As previously noted, wireless transmitter 104 may be configured, in accordance with some embodiments, to output an RF signal 105. In accordance with some embodiments, RF Signal 105 may be, for example, a Bluetooth signal of a frequency of about 2.4-2.485 GHz. In accordance with some embodiments, RF signal 105 may be, for example, a long range (LoRa) signal of a frequency in a 915 MHz ISM band. In accordance with some embodiments, RF signal 105 may be, for example, a cellular signal.

Regardless of its type, RF signal 105 may include data pertaining to whether movement has been detected by motion detection sensor 114 (e.g., which may be indicative of the armed or triggered status of an associated trap 10), in accordance with some embodiments. In some cases, RF signal 105 also optionally may include additional and/or different data beyond that pertaining to detected movement. For instance, in accordance with some embodiments, RF signal 105 may include data pertaining to a unique identifier associated with device 100. In accordance with some embodiments, RF signal 105 may include data pertaining to any one (or combination) of: a manufacture code associated with device 100; a status of device 100; a power level of a power supply 116 of device 100; a sequence number pertaining to a unique data packet of RF signal 105; and an output of a sensor of device 100. Other suitable data contents of RF signal 105 will depend on a given target application or end-use and will be apparent in light of this disclosure.

In accordance with some embodiments, a given recipient of RF signal 105 may forward such information to one or more other elements of system 1000, such as, for example, internet/cloud 904 to be stored at server database 906. For instance, in accordance with some embodiments, in response to receipt of RF signal 105, a given recipient computing device 908, 910 or gateway 902 may transmit an RF signal (e.g., a Wi-Fi or cellular signal) to server database 906 through internet/cloud 904. In accordance with some embodiments, RF signal 105 may be transmitted periodically, on-demand, or as otherwise desired and may be received by any (or all) computing devices 908, 910 and gateway(s) 902 within range.

Returning to FIG. 1, system 1000 further may include a gateway 902, which may be configured, in accordance with some embodiments, to receive data from RF signal 105 transmitted by device 100 and transmit that data to a server database 906 via internet/cloud 904. To such ends, gateway 902 may be configured to utilize any one, or combination, of suitable communication protocols, wired or wireless, such as, for example, Universal Serial Bus (USB), Ethernet, FireWire, Wi-Fi, Bluetooth, or cellular, to name a few. In accordance with some embodiments, gateway 902 may be any one, or combination, of fixed Bluetooth-to-Wi-Fi, cellular-to-Wi-Fi, or cellular-to-Bluetooth bridge/hub devices. In accordance with some embodiments, gateway 902 may be LoRa-compatible. Gateway 902 may be used to read all (or some sub-set of) RF signal(s) 105 from any device(s) 100 within range and to forward the information over a network interface to internet/cloud 904 and server database 906. In accordance with some embodiments, when gateway 902 receives an RF signal 105, it may deliver data from that RF signal 105 to server database 906 (via the internet/cloud 904), where it may be viewed, for instance, by a given computing device 908, 910, for instance, via a web browser or other suitable means and/or by a computing device 908, 910 having access to server database 906. In accordance with some embodiments, gateway 902 may be configured to receive such a RF signal 105 and relay information obtained therefrom to server database 906, providing for a mechanism by which the integrity status of system 1000, in part or in whole, may be determined. Other suitable configurations for gateway 902 will depend on a given application and will be apparent in light of this disclosure.

In accordance with some embodiments, system 1000 further may involve one or more computing devices 908, 910, mobile or otherwise. A given computing device 908, 910 may be, for example, any one (or combination) of a laptop/notebook computer, a sub-notebook computer, a tablet computer, a desktop computer, a mobile phone, a smartphone, a personal digital assistant (PDA), a cellular handset, or other reader device configured to receive RF signal 105. A given computing device 908, 910 may be configured to utilize any one, or combination, of suitable communication protocols, wired or wireless, such as, for example, Universal Serial Bus (USB), Ethernet, FireWire, Wi-Fi, Bluetooth, or cellular, to name a few. A given computing device 908, 910 may be configured, in accordance with some embodiments, for monitoring and controlling operation of any part or the totality of system 1000 and its various constituent elements. In some cases, a given computing device 908, 910 may be a dedicated reader device configured specifically to such ends, whereas in some other cases, a given computing device 908, 910 may be a general computing device configured for use to such ends, optionally hosting one or more applications to facilitate its use in monitoring and controlling operation of system 1000. In accordance with some embodiments, a given computing device 908, 910 may be utilized in assigning/pairing a given device 100 with a given trap 10 and in monitoring one or more devices 100. In accordance with some embodiments, a given computing device 908, 910 may be configured to access server database 906 to display the current location of a given device 100 disposed at a given trap 10. In accordance with some embodiments, a given computing device 908, 910 may be configured to pull from server database 906 any user-designated names of devices 100 and display them for user review, thereby facilitating the user's understanding of which specific traps 10 and which specific locations are being considered. In accordance with some embodiments, a given computing device 908, 910 may host a browser or other software application configured to facilitate review of information pertinent to any part or the totality of system 1000 and its various constituent elements. Other suitable configurations for computing device(s) 908, 910 will depend on a given application and will be apparent in light of this disclosure.

In accordance with some embodiments, system 1000 further may involve a server database 906, which may be accessible through the internet/cloud 904. In some embodiments, server database 906 may be cloud-based, in part or in whole. As a means of data storage, server database 906 may be configured to store information saved thereat, for instance, by any of device(s) 100, gateway(s) 902, and computing device(s) 908, 910. In an example case, server database 906 may store information about assignment/pairing of a given device 100 with a given trap 10, which may be retrieved by a given computing device 908, 910, for instance. In another example case, server database 906 may store information about user-designated familiar names for devices 100 and traps 10, which may be retrieved by a given computing device 908, 910, for instance. In a more general sense, server database 906 may allow for a given desired degree of inter-networking of the components of system 1000 and other elements as part of the internet of things (IOT), in accordance with some embodiments. Other suitable configurations for server database 906 will depend on a given application and will be apparent in light of this disclosure.

In accordance with some embodiments, RF signal 105 may be received by any one (or combination) of a given computing device 908, 910, gateway 902, cellular base station 912, and cellular provider network 914 within range, and information therefrom may be delivered through the internet/cloud 904 to server database 906. As previously noted, RF signal 105 may include data pertaining to the status (e.g., armed or triggered) of a trap 10 associated therewith. The information stored at server database 906 may be accessed to monitor and track a given device 100 and trap 10 and to control overall system 1000 operation. Data may be viewed, for instance, by a given computing device 908, 910 via a web browser or other suitable means having access to server database 906. The frequency at which a given computing device 908, 910 or a given gateway 902 may be utilized to monitor for an RF signal 105 from a given device 100 may be customized, as desired for a given target application or end-use. In an example case, monitoring for an RF signal 105 from a given device 100 may occur only occasionally (e.g., once per day, hour, or otherwise) or otherwise as frequently as desired.

In accordance with some embodiments, system 1000 may be configured to provide a user to an alert as to the armed or triggered status of a given trap 10 with an attendant device 100. For instance, in some cases, a user may receive from any one or more elements of system 1000 a text message, an electronic mail (e-mail) message, a phone call, or other suitable alert communication indicating that movement has been detected via device 100 and/or that device 100 is operational (e.g., in proper working order).

Methodology

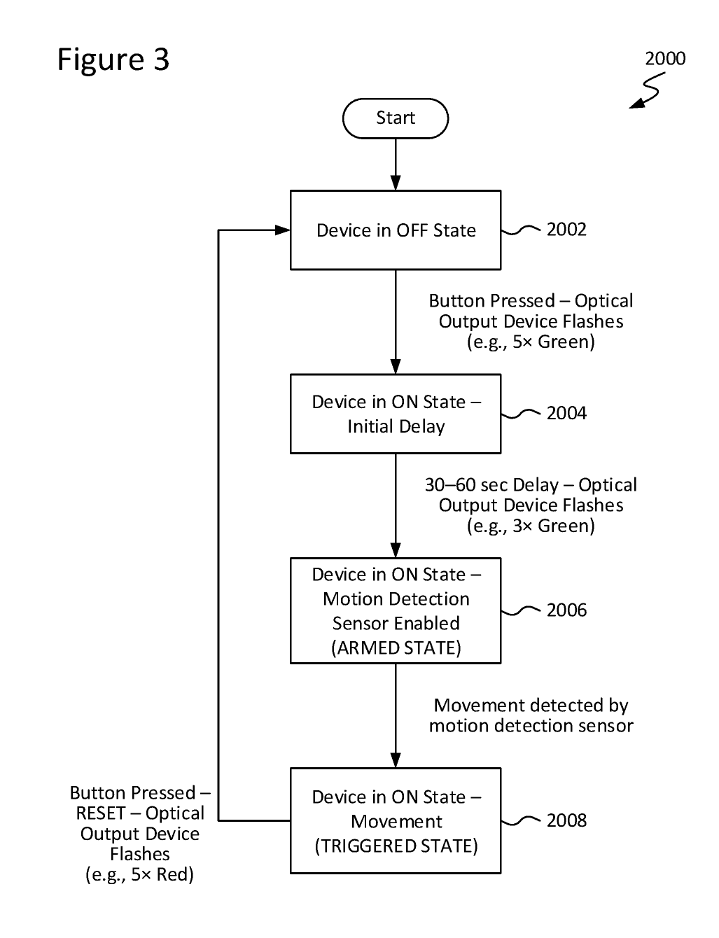

FIG. 3 is a flow diagram illustrating a method 2000 of operating a wireless monitoring device 100 in accordance with an embodiment of the present disclosure. As can be seen, method 2000 may begin as in block 2002 with device 100 being in an OFF state. The OFF state may be, for example, a low-power mode, sleep mode, hibernation mode, or powered-off mode.

Method 2000 may continue as in block 2004 with device 100 transitioning to an ON state, with an initial delay. To that end, a button 122 may be actuated to begin the transition, in accordance with some embodiments. If present, an optical output device 118 may provide optical output (e.g., flashing light), indicative that device 100 is transitioning out of its OFF state to its ON state, with the initial delay. In accordance with some embodiments, while in the OFF state (block 2002) or in the ON state with initial delay (block 2004), device 100 may be operatively interfaced with (e.g., mounted to, positioned in contact with, or otherwise disposed sufficiently proximate to) a given trap 10, as previously described, to permit device 100 to detect either (or both): (1) movement of trap 10, such as when triggered; or (2) movement of the organism trapped by trap 10. The initial delay may provide sufficient time to operatively interface device 100 and trap 10 as desired without fear of accidentally triggering device 100. The duration of the initial delay may be customized, as desired for a given target application or end-use, and in at least some cases, may be, for example, in the range of about 30-60 seconds, though greater or lesser periods may be provided for, in accordance with some embodiments. If present, an optical output device 118 may provide optical output (e.g., flashing light), indicative that device 100 is in its ON state with the initial delay counting down.

Method 2000 may continue as in block 2006 with device 100 remaining in its ON state once the initial delay has expired. At this point, device 100 may be in its armed state, wherein motion detection sensor 114 may be ready to detect either (or both): (1) movement of trap 10, such as when triggered; or (2) movement of the organism trapped by trap 10.

Method 2000 may continue as in block 2008 with device 100 remaining in its ON state and transitioning from its armed state (block 2006) to its triggered state. In accordance with some embodiments, this transitioning may occur, for example, when motion detection sensor 114 detects either (or both): (1) movement of trap 10, such as when triggered; or (2) movement of the organism trapped by trap 10. In the triggered state, device 100 may transmit an RF signal 105 including data pertaining to the detected movement, indicating a possible triggering of an associated trap 10. In accordance with some embodiments, device 100 may enter the triggered state and remain there indefinitely until device 100 is reset. In accordance with some embodiments, after the initial arming period, any movement detected by device 100 may cause device 100 to latch in the motion detected state and transmit RF signal 105, which may be received by either (or both) a given computing device 908, 910 and a gateway 902 within range.

Method 2000 may return to block 2002 with device 100 transitioning from the triggered state to the OFF state, as previously described. To that end, a button 122 may be actuated to begin the transition (e.g., reset). If present, an optical output device 118 may provide optical output (e.g., flashing light), indicative that device 100 is transitioning out of the ON state to the OFF state. When trap 10 is cleared and/or reset, device 100 may be reset (e.g., such as by pushing button 122), at which point device 100 may cease broadcasting RF signal 105. As will be appreciated in light of this disclosure, in turning off the broadcasting of RF signal 105 when device 100 is not in use, power savings may be realized for power supply 116.

In accordance with some embodiments, an identification and pairing process of a device 100 with a given trap 10 may involve any one or combination of operating a button 122, tapping or double-tapping device 100 (e.g., such as on a housing 102 thereof), and/or merely placing a device 100 in sufficient proximity to a given computing device 908, 910 to be used in monitoring device 100. Device 100 initially may be identified to a given computing device 908, 910 (e.g., to an application hosted by such computing device 908, 910). The location of device 100, and thus the associated trap 10, may be designated and named on an application hosted by a given computing device 908, 910.

What is claimed is:

1. A wireless monitoring device comprising:
a motion detection sensor configured to detect at least one of:
movement of a pest or animal trap with which the wireless monitoring device is operatively interfaced; and
movement of an organism trapped by such trap;
a wireless transmitter configured to transmit a radio frequency (RF) signal including data pertaining to:
the detected movement; and
a unique identifier associated with the wireless monitoring device; and
a processing element configured to instruct the wireless transmitter to transmit the RF signal in response to detection of the movement by the motion detection sensor.

2. The wireless monitoring device of claim 1, wherein the motion detection sensor is configured to output a first wake-up signal, which first wake-up signal results in the processing element transitioning out of a first low-power state and outputting a second wake-up signal to the wireless transmitter, which second wake-up signal results in the wireless transmitter transitioning out of a second low-power state and transmitting the RF signal.

3. The wireless monitoring device of claim 1, wherein the wireless transmitter is configured to:
periodically transmit the RF signal at a first transmission rate; and
transmit, for a designated period, the RF signal at a second transmission rate upon the movement detection, wherein the second transmission rate is greater than the first transmission rate.

4. The wireless monitoring device of claim 3, wherein the wireless transmitter is configured to transmit the RF signal at the second transmission rate until at least one of:
the wireless monitoring device is reset from a triggered state to an armed state;
a predetermined amount of time has elapsed;
a power supply of the wireless monitoring device is depleted; and
the wireless monitoring device is turned off.

5. The wireless monitoring device of claim 1, wherein the wireless transmitter is configured to transmit the RF signal periodically.

6. The wireless monitoring device of claim 1, wherein the wireless transmitter is configured to transmit the RF signal:
at a first transmission rate when the wireless monitoring device is in a low-power state; and
at a second transmission rate when the wireless monitoring device is in an active state, wherein the second transmission rate is greater than the first transmission rate.

7. The wireless monitoring device of claim 1, wherein the wireless transmitter is configured as a wireless transceiver device, having both wireless transmission and wireless reception capabilities.

8. The wireless monitoring device of claim 1, further comprising a timer configured to output a first wake-up signal, which first wake-up signal results in the processing element transitioning out of a first low-power state and outputting a second wake-up signal to the wireless transmitter, which second wake-up signal results in the wireless transmitter transitioning out of a second low-power state and transmitting the RF signal.

9. The wireless monitoring device of claim 8, wherein the timer is configured to output the first wake-up signal periodically.

10. The wireless monitoring device of claim 1, wherein the RF signal is either:
a Bluetooth signal of a frequency in the range of 2.4-2.485 GHz;
a long range (LoRa) signal of a frequency in a 915 MHz ISM band; or
a cellular signal.

11. The wireless monitoring device of claim 1, wherein the RF signal further includes data pertaining to at least one of:
a manufacture code associated with the wireless monitoring device;
a status of the wireless monitoring device;
a power level of a power supply of the wireless monitoring device;
a sequence number pertaining to a unique data packet of the RF signal; and
an output of a sensor of the wireless monitoring device.

12. The wireless monitoring device of claim 1, further comprising a button configured to at least one of:
arm and reset the wireless monitoring device;
wake the wireless monitoring device from a low-power state; and
begin a time delay for arming the wireless monitoring device.

13. A system comprising:
the wireless monitoring device of claim 1; and
the trap, wherein the wireless monitoring device is formed integrally with the trap.

14. A system comprising:
the wireless monitoring device of claim 1; and
the trap, wherein the wireless monitoring device is operatively interfaced with the trap via a holder.

15. A method of wirelessly monitoring a pest or animal trap, the method comprising:
detecting, via a motion detection sensor of a wireless monitoring device operatively interfaced with the trap, at least one of:
movement of the trap; and
movement of an organism trapped by the trap; and
transmitting, via a wireless transmitter of the wireless monitoring device, a radio frequency (RF) signal including data pertaining to:
the detected movement; and
a unique identifier associated with the wireless monitoring device.

16. The method of claim 15, further comprising:
outputting, via the motion detection sensor, a first wake-up signal, which first wake-up signal results in a processing element of the wireless monitoring device transitioning out of a first low-power state and outputting a second wake-up signal to the wireless transmitter, which second wake-up signal results in the wireless transmitter transitioning out of a second low-power state and transmitting the RF signal.

17. The method of claim 15, wherein the transmitting of the RF signal occurs:
periodically at a first transmission rate; and
for a designated period at a second transmission rate upon the movement detection, wherein the second transmission rate is greater than the first transmission rate.

18. The method of claim 17, wherein the transmitting of the RF signal at the second transmission rate occurs until at least one of:
the wireless monitoring device is reset from a triggered state to an armed state;
a predetermined amount of time has elapsed;
a power supply of the wireless monitoring device is depleted; and
the wireless monitoring device is turned off.

19. The method of claim 15, wherein the RF signal is either:
a Bluetooth signal of a frequency in the range of 2.4-2.485 GHz;
a long range (LoRa) signal of a frequency in a 915 MHz ISM band; or
a cellular signal.

20. The method of claim 15, wherein the RF signal further includes data pertaining to at least one of:
a manufacture code associated with the wireless monitoring device;
a status of the wireless monitoring device;
a power level of a power supply of the wireless monitoring device;
a sequence number pertaining to a unique data packet of the RF signal; and
an output of a sensor of the wireless monitoring device.
